(19) United States
(12) Patent Application Publication
(10) Pub. No.: US 2022/0063679 A1
(43) Pub. Date: Mar. 3, 2022

(54) LOGISTICS SYSTEM

(71) Applicant: KARMA AUTOMOTIVE LLC, Irvine, CA (US)

(72) Inventors: Stefan GUDMUNDSSON, Irvine, CA (US); Lance Liang ZHOU, Irvine, CA (US)

(73) Assignee: KARMA AUTOMOTIVE LLC, Irvine, CA (US)

(21) Appl. No.: 17/412,453

(22) Filed: Aug. 26, 2021

Related U.S. Application Data
(60) Provisional application No. 63/070,432, filed on Aug. 26, 2020.

(51) Int. Cl. B60W 60/00

(52) U.S. Cl. CPC B60W 60/00256; B60W 2420/52; B60W 2556/60

(57) ABSTRACT

An autonomous delivery system configured to provide optimized delivery for packages and provide services to multiple locations along a path. The delivery system includes a vehicle capable of autonomously driving and providing the packages and/or services required.

### GENERAL DESCRIPTION

The present disclosure relates to a logistics system. Specifically, an autonomous or semi-autonomous delivery system utilizing vehicle driving assistance in order to optimize efficient distribution of goods.

Logistics services provides an essential business to many companies. Logistics services provides product distribution for businesses and shipping for consumers. Most consumer goods rely on logistics services in order to be properly distributed. Many items are delivered via these services, such as goods from e-commerce businesses and food from restaurants. Thus logistics services that provide pickup and deliveries has become a necessity in today's world. Current delivery and pickup services are provided with an inefficient system. For example, vehicles are required to start and stop multiple times a day which, amongst other disadvantages, will reduce vehicle lifespan. With the increasing demand in delivery and pickup services, there is a need for increasing efficiency in delivery of these goods.

### BRIEF DESCRIPTION OF THE DRAWINGS

The features, aspects, and advantages of the disclosed logistics system will become apparent from the following description, and the accompanying exemplary embodiments shown in the drawings, which are briefly described below.

FIG. 1 is a logistic system according to a first exemplary embodiment.

FIG. 2 is a logistic system according to a second exemplary embodiment.

FIG. 3 is exemplary schematic of a vehicle and drones for use with logistic systems, such as the systems disclosed herein.

### DETAILED DESCRIPTION

According to one disclosed embodiment, a system to deliver packages for a plurality of locations is provided. The delivery system includes a vehicle configured to follow a movement path based on the plurality of locations. The vehicle is configured to calculate predetermined stop locations along the path for a delivery person to return to. The vehicle is configured to carry corresponding packages associated with each plurality of locations. The vehicle includes vehicle sensors configured to navigate the vehicle at a low speed along the path. Wherein the predetermined stop locations may be modified by the vehicle depending on data from the vehicle sensor in order to dynamically optimize the path.

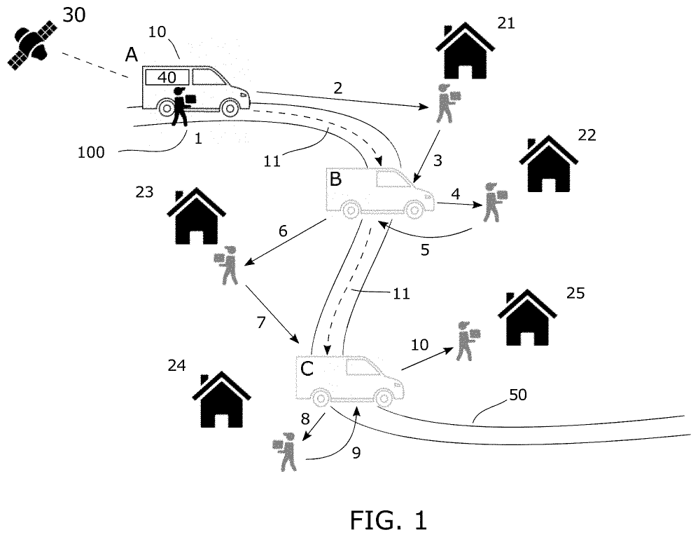

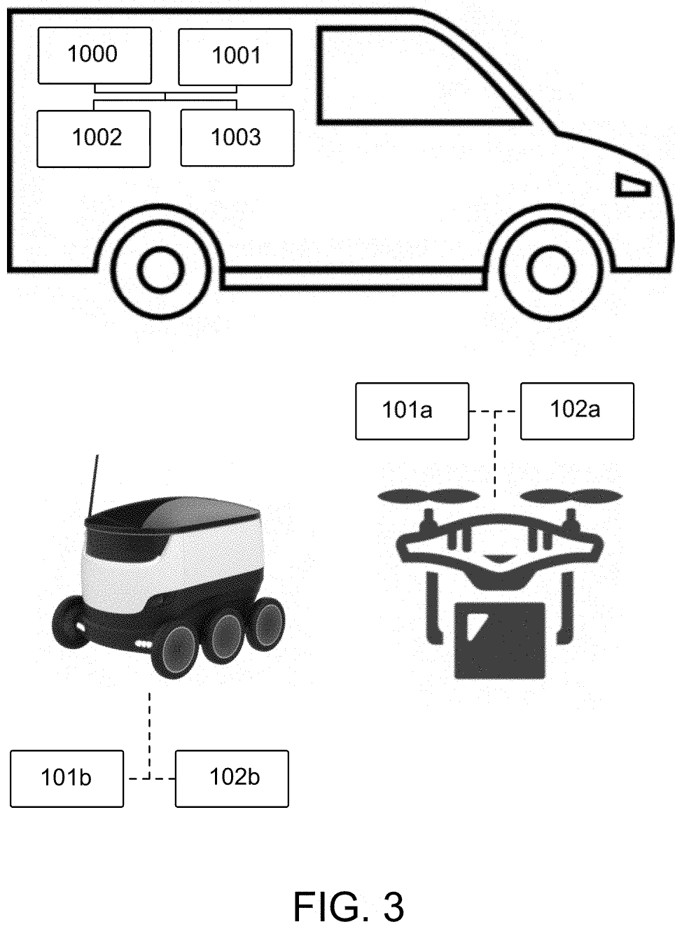

FIG. 1 illustrates a logistics system having a vehicle 10 and a delivery person 1 according to a first embodiment. As used herein, “person” may correspond to one or more persons or robots (e.g., multiple delivery persons or personnel). The delivery vehicle may include various different types of vehicles such as battery powered electric vehicles utilizing electric propulsion, internal combustion vehicles, or hybrid vehicles (electric, internal combustion combination, and fuel cell). The vehicle 10 may include vehicle systems 40, which may include vehicle sensors, one or more computer processors, and one or more computer memories (See FIG. 3). The vehicle may communicate with a global navigation satellite system (GNSS) 30. The GNSS may send data (e.g. location data) to the vehicle memory via a transceiver (or any data/signal receiving device) and the data configured to be read and utilized by the vehicle processor. The GNSS 30 may be a centimeter-level (cm-level) system in order to provide the vehicle with accurate positional reading. The GNSS system 30 may also communicate with the person 1, via an electronic device having a processor and memory, in order provide the delivery system, as shown in FIG. 1, positional data to be utilized by the system to control operation of the vehicle. The vehicle 10 is preferred to operate autonomously in all embodiments described herein. Although a GNSS system 30 is shown a cellular positioning (LTE/5G), Wi-Fi, or other geolocation positioning systems may be utilized. Person 1 may also include one or more robots which is shown in one embodiment as described below.

A first embodiment of the system allows the vehicle 10 to autonomously drive to fulfill the orders for multiple delivery drop-off and/or pickup locations 21-25. The person 1 may also be tracked via the geolocation system 30, via the electronic device carried by the person 1. The vehicle 10 may utilize a combination of the geolocation system and driving sensors in order to follow the person 1. The vehicle memory is configured to store sensor data accumulated during operation of the vehicle(s) from the driving sensors and wherein the driving sensor data is configured to be retrieved from the memory and utilized by the vehicle processor. The vehicle may be configured to follow path 11 which may be a predetermined path determined by target drop-off and/or pickup locations 21-25. The predetermined path may be calculated by the vehicle processor by reading and analyzing target drop-off and/or pickup locations data stored in the memory of the vehicle. The predetermined path calculation may include route finding methods known to one skilled in the art of navigation. The person 1 may carry items stored in the vehicle 10. The items may be delivered to the different drop-off locations 21-25. Person 1 may take paths 2-10 in order to provide deliveries to drop-off locations 21-25. The path 11 may correspond the closest road, street, or pathway 50 which the vehicle may take in order to connect different locations 21-2.

According to one disclosed embodiment a delivery system including a vehicle having one or more vehicle sensor, an electronic vehicle processor, and a vehicle memory is provided. The one or more vehicle sensor and the electronic vehicle processor is in communication with the vehicle memory and the one or more vehicle sensor configured to send sensor data to the vehicle memory. A positioning system may be configured to continuously communicate with the vehicle memory by continuously sending location data configured to be received by and stored in the vehicle memory, wherein the location data is the current location of the vehicle. The electronic vehicle processor is configured to read the computer memory in order to continuously calculate a path depending on the location data of the current location of the vehicle and sensor data received by the vehicle memory. The path includes a plurality of stops calculated by the vehicle processor by using vehicle sensor data and predetermined delivery location data stored in the vehicle memory, wherein the predetermined delivery location data represents predetermined delivery locations. The vehicle includes a powertrain system controlled by the vehicle processor. The vehicle processor is configured to send commands to the powertrain system in order to autonomously drive the vehicle along the path.

According to another disclosed embodiment a vehicle is provided. The vehicle includes an electronic vehicle processor one or more vehicle sensor, a vehicle memory, wherein the vehicle sensors and the electronic vehicle processor are in communication with the vehicle memory and the one or more vehicle sensors configured to send sensor data to the vehicle memory. A transceiver is provided to communicate with a positioning system continuously communicating with the vehicle memory by continuously sending location data configured to be received by the transceiver and stored in the vehicle memory. The location data may correspond to the current location of the vehicle. The electronic vehicle processor is configured to read the computer memory in order to continuously calculate a path depending on the location data of the current location of the vehicle and sensor data received by the vehicle memory. The path includes a plurality of stops calculated by the vehicle processor by using vehicle sensor data and predetermined delivery location data stored in the vehicle memory. The vehicle includes a powertrain system controlled by the vehicle processor. The vehicle processor may be configured to send commands to the powertrain system in order to autonomously drive the vehicle along the path.

The vehicle 10 may stop at predetermined points along path 11. Stop locations ‘B’ and ‘C’ are exemplary stopping points along path 11 where the vehicle 10 is configured stop for the person. For example, once a delivery mode is initiated, the vehicle may stop at location ‘A’ allowing person 1 to retrieve items from vehicle 10 to take path 2 to deliver to drop-off location 21. The vehicle 10 may then move to location ‘B’ allowing the person 1 to take path 3 to retrieve corresponding package(s) in the vehicle 10 in order to deliver to location 22 via path 4. The person 1 may then return to the vehicle 10 at location ‘B’ to retrieve corresponding package(s) for location 23. The person may then take path 6 in order to deliver the package to location 23. After the person 1 leaves via path 6, the vehicle may move to location ‘C’. The person may meet with the vehicle via path 7 to retrieve corresponding package(s) for location 24. Once the person 1 delivers the corresponding packages via path 8, the person may return to the vehicle via path 9 to retrieve and deliver corresponding package(s) to location 25 via path 10. These predetermined points may be received via data sent by the GNSS 30 and/or received via data sent by the electronic device of the person 1. The predetermined points are stored in the memory of the vehicle 10 and are retrieved and utilized by the vehicle processor. The vehicle processor then commands the vehicle power train system, via signals, in order to set the vehicle to autonomously drive along path 11 while stopping at the predetermined points.

Path 11 may include than two locations shown in FIG. 1. For example, the vehicle 10 may stop at any point along path 11 in order for the vehicle to be at the optimal location for the person 1. Optimal location may be a location corresponding to a time and/or distance for the person to complete each separate delivery to corresponding locations, thus there may be a corresponding stop location for each corresponding delivery location. The optical location may be calculated by the vehicle processor or from an outside computing unit (e.g. cloud network). The calculation may include route finding methods known to one skilled in the art of navigation utilizing a combination of data sent by the GNSS 30 and/or data sent by the electronic device of the person 1.

The system may also accommodate undeliverable goods. For example, packages that require a signature may be returned to the vehicle 10 and be included in the next path calculation on the next scheduled delivery date for the undelivered package. Thus, there may be a dynamic path calculation for a given delivery schedule. The described system may also be utilized to pick up goods for corresponding locations 21-25. For example, goods may be scheduled for pick up for one or more locations 21-25 and added into the calculation of path 11. These can be, for example, returns or goods required for product distribution elsewhere or even along path 11.

The vehicle 10 may utilize vehicle systems 40 (e.g. vehicle processor, vehicle memory, vehicle sensors) and Geolocation system 30 in order to stay in or on a road, street, or pathway 50. The vehicle 10 may follow the person 1 at a low speed, typically around 2-3 MPH, in order to aid the person to provide deliveries to locations 21-25. Vehicle sensors and processor 40 may include optical and radar sensors such as cameras, lidar, radar, and infrared sensors. All of the aforementioned sensors utilize radiation and waves in the electromagnetic spectrum. Radar waves may be emitted by the vehicle and bounced off objects in the vicinity of the vehicle and returned to radar sensors on the vehicle. Alternatively, optical sensors may detect the radiation or light reflected or omitted by an object. Data related to the waves is stored and utilized by the vehicle processor in order to provide autonomous driving. Optical sensors such as cameras may utilize object recognition algorithms known to one skilled in the art in order to provide further refinement to autonomous driving. The system also may include a controller which receives data from the sensors in order to process the data and provide output commands for the vehicle and its systems and functions. If a predetermined path has not been mapped to the vehicle 10, the vehicle may follow the person using vehicle sensors and controller 40 via a follow mode operation of the system. The vehicle systems 40 may track the person 1 in the follow mode. As the person 1 travels between locations 21-25, the vehicle may move along path 11 in order to follow the person 10. This control methodology and method of operation of the vehicle allows the person to optimize distance traveled or time to each location 21-25 and the vehicle 10. The vehicle may be controlled using vehicle systems 40 in order to maintain a distance threshold to the person 1 while maintaining the vehicle within the road, street or pathway 50. While operating in the follow mode, the vehicle 10 may stop moving after the person 1 is located closer than a threshold distance so that the person may retrieve corresponding package(s). Vehicle systems 40 also allow the vehicle to safely navigate through road, street, or pathway 50 along path 11 by utilizing sensors such as lidar, radar, or optical cameras in communication with the memory and processor of the vehicle.

The vehicle 10 as shown in FIG. 1 may also require no personnel to operate. The vehicle may operate as a hub to retrieve goods. The vehicle 10 may directly or indirectly notify locations 21-25 that a package is ready to be picked up. This configuration may allow users to pick up packages when the vehicle arrives at predetermined locations along path 11. As a result, the system provides for a “self-serve” option for service to customers. The vehicle may serve as a mobile pickup locker. The vehicle 10 may make stops along path 11 and send notifications to corresponding locations 21-25 or users associated with locations 21-25 that goods are available for pickup and the vehicle may stay at a stop location for a set time. If goods are not picked up the pickup may be rescheduled or called back to the stop location at the end of the route. The vehicle may also receive goods in order to provide pickup and production distribution services.

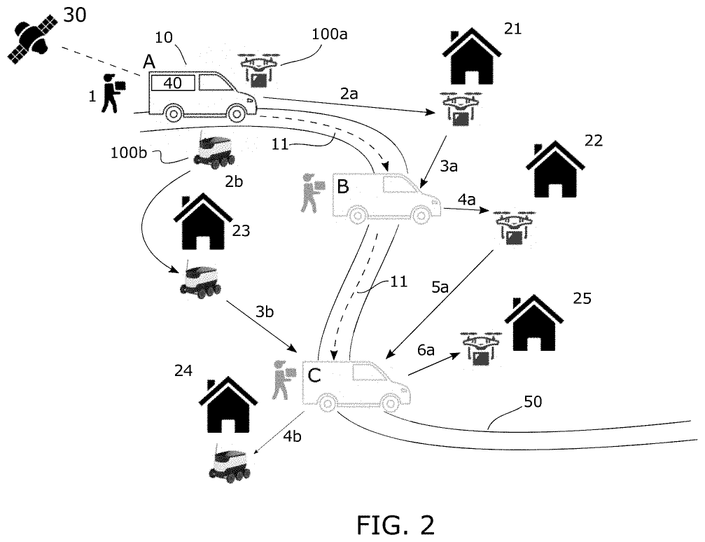

FIG. 2 illustrates an exemplary embodiment of a delivery system utilizing autonomous delivery drones 100a and 100b. The drones may be ground based drones or airborne drones. The drones 100a and 100b may communicate with the vehicle 10 and geolocation system 30. In this embodiment, vehicle 10 may act as a hub for the drones to pick up items for locations 21-25. The vehicle may move to predetermined locations ‘A’, ‘B’ and ‘C’ along a predetermined path 11 in order for the drones 100a and 100b to make deliveries. The predetermined locations are calculated based on the position of drop-off locations 21-25. The vehicle may be operated in order to minimize the distance and/or time required for drones to deliver the required packages to drop-off locations 21-25. The vehicle 10 may also follow the drones 100a and 100b using the vehicle system 40 similar to the system described in embodiment 1 in FIG. 1. The vehicle may be configured to operate to maintain a certain average distance between each drone 100a and 100b.

In this embodiment, the person 1 may only be utilized for putting packages onto the drones 100a and 100b. However, the vehicle may be fully autonomous and the drones 100a and 100b may not require personnel 1 to load packages and may be configured to retrieve packages directly from the vehicle 10. Each drone may be tasked to complete deliveries. The distribution of the deliveries may be calculated in order to provide the least distance and/or time for the drones 100a and 100b. The drone 100a may be controlled follow paths 2a, 3a, 4a, 5a, and 6a in order to complete the tasked deliveries. Likewise, drone 100b may be controlled follow paths 2b, 3b, 5b in order to complete the tasked deliveries.

While embodiments described above is utilized in a delivery system for packages, other goods such as food or mail can be implemented. For example, vehicle 10 may be a food truck allowing delivery of food for locations 21-25. The vehicle 10 may stop at stop locations along path 11 and allow people to order food from the vehicle 10. The system described in FIG. 1 and FIG. 2 may communicate to a network system (e.g. cloud network, Wi-Fi, Bluetooth) in order to provide commands to the vehicle 10 and drones 100a/100b. The network may include machine learning algorithms in order to provide optimization of the logistics system described.

The vehicle 10 may also receive input from locations 21-25 or users corresponding to locations 21-25. For example, the users may provide to the logistics system a notification of package pickup. This notification may be in the form of data sent to the network via any suitable wired or wireless manner that communicates with the network. The notification data may include package information such as package volume, package weight, and whether or not the package is fragile. This notification data allows the system 40 of the vehicle to provide an optimized path for the vehicle to travel. For example, the vehicle may pick up fragile packages last in order to minimize the probability of damage to the package. Also, by way of example, if the package is of relatively large size, the vehicle system 40 may provide an optimized path where a certain volume of packages must be delivered before retrieving the package of the large size so that the large package may fit into the vehicle 10. Thus, the vehicle controller and sensor 40 may include sensors that receive data regarding the cargo of the vehicle 10 in order to make the most optimal delivery/pickup route. The determination and analysis of the path may be performed in the network or cloud and provided to the vehicle controller 40 for controlling the path of the vehicle 10.

As shown in FIG. 3, the vehicle 10 may include various vehicle systems 40 which include a vehicle processor 1000, a vehicle memory 1001, driving sensors 1002, and transceiver 1003. The vehicle processor 1000 and driving sensors 1002 are configured to communicate with the vehicle memory 1001. The driving sensors 1002 provide information in the form of data and stores the information in the vehicle memory 1001. Inputs received and outputs sent to the vehicle are stored in the vehicle memory 1001. The vehicle processor 1000 may also be configured to communicate with other vehicle systems such as the power train system, in order to control and automate the driving of the vehicle 10. The processor utilizes data stored in the vehicle memory 1001 in order to execute the method and system disclosed above. Each of the drones 100a and 100b may also include its own corresponding drone processor configured to communicate with a corresponding drone memory. The logistics method and system described above may be stored as computer readable instructions written in a number of programming languages for use with many computer architectures or operating systems within the vehicle/drone processor 101a/101b or the vehicle/drone memory 102a/102b. Further, such instructions may be stored using any memory technology, present or future, including but not limited to, semiconductor, magnetic, or optical, or transmitted using any communications technology, present or future, including but not limited to optical, infrared, or microwave.

It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web. The vehicle memory 1001 may comprise at least one of a volatile memory unit, such as random access memory (RAM) unit, or a non-volatile memory unit, such as an electrically addressed memory unit or a mechanically addressed memory unit. For example, the electrically addressed memory may include a flash memory unit. For example, the mechanically addressed memory unit may include a hard disk drive. The memory may comprise a storage medium, such as at least one of a data repository, a data mart, or a data store. For example, the storage medium may comprise a database, including distributed, such as a relational database, a non-relational database, an in-memory database, or other suitable databases, which may store data and allow access to such data via a storage controller, whether directly and/or indirectly, whether in a raw state, a formatted state, an organized stated, or any other accessible state. The memory may comprise any type of storage, such as a primary storage, a secondary storage, a tertiary storage, an off-line storage, a volatile storage, a non-volatile storage, a semiconductor storage, a magnetic storage, an optical storage, a flash storage, a hard disk drive storage, a floppy disk drive, a magnetic tape, or other suitable data storage medium. Calculations made by the processor above can be continuous such that the path and/or stops can be made dynamically in order to adapt to changing road conditions and traffic.

In sum, a system of providing an improved delivery system is provided. The systems described above provide for reduced wear and tear on the vehicle 10 due to less frequent starting and stopping. The system allows the vehicle to have longer operating range as starting/stopping reduces the range of the vehicle, especially for electric vehicles utilizing a battery for powering a powertrain system including traction motors. Furthermore, the system allows for more efficient and effective utilization of the delivery personnel, as they do not have to both drive and provide delivery. Additionally, the vehicle may be fully controlled at all times in order to provide effect delivery routes and schedules.

Data as described herein can be at least one of a data packet, an electronic file, network packet, or any other electronic combination of various numbers, characters, strings, and/or Boolean values compiled into one or more objects representing the data entity. Components of the data described herein may be data portions of the data packet, electronic file, network packet. For example, a prescription of the referral data as described herein may be a data field in the referral data representing the prescription. Data described herein is configured to be received by the memory and processed by the processor described above or any other components configure to receive and process data.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the delivery system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A delivery system comprising:
a vehicle having one or more vehicle sensors, an electronic vehicle processor, and a vehicle memory, wherein the one or more vehicle sensors and the electronic vehicle processor is in communication with the vehicle memory and the one or more vehicle sensors is configured to send sensor data to the vehicle memory;
a positioning system configured to continuously communicate with the vehicle memory by continuously sending location data configured to be received by and stored in the vehicle memory, wherein the location data corresponds to a current location of the vehicle;
wherein the electronic vehicle processor is configured to read the computer memory in order to continuously calculate a path depending on the location data and the sensor data received by the vehicle memory;
wherein the path includes a plurality of locations where the vehicle will stop moving, and wherein the stop locations are calculated by the vehicle processor by using vehicle sensor data and predetermined delivery location data stored in the vehicle memory,
wherein the predetermined delivery location data corresponds to predetermined delivery locations; and
wherein the vehicle includes a powertrain system controlled by the vehicle processor; and
wherein the vehicle processor is configured to send commands to the powertrain system in order to autonomously drive the vehicle along the path.

2. The delivery system of claim 1, wherein the positioning system is a global navigation satellite system (GNSS).

3. The delivery system of claim 1, wherein the vehicle sensor is at least one of a radar and lidar system.

4. The delivery system of claim 3, wherein the vehicle sensor senses electromagnetic waves from external objects and stores the data corresponding to the electromagnetic waves in the vehicle memory.

5. The delivery system of claim 4, wherein the data representing the electromagnetic wave in the vehicle memory is utilized by the processor to follow a delivery person.

6. The delivery system of claim 5, wherein each stop of the plurality of stops are calculated as the minimum distance for the person to complete a delivery associated with each predetermined delivery location data.

7. The delivery system of claim 1, further comprising one or more autonomous drones configured to aid delivery of objects to predetermined delivery locations.

8. The delivery system of claim 1, wherein the vehicle is configured to receive an input signal from one predetermined delivery location of the predetermined delivery locations, wherein the input signal is information regarding a package stored in the vehicle associated with the one predetermined delivery location.

9. The delivery system of claim 8, wherein the vehicle processor is configured to recalculate the path by using the input signal in the recalculation of the path.

10. The delivery system of claim 1, wherein the powertrain system is an powertrain system providing electric propulsion.

11. A vehicle comprising:
an electronic vehicle processor
one or more vehicle sensors;
a vehicle memory, wherein the vehicle sensors and the electronic vehicle processor is in communication with the vehicle memory and the one or more vehicle sensor configured to send sensor data to the vehicle memory;
a transceiver configured to communicate with a positioning system;
wherein the positioning system is configured to continuously communicate with the vehicle memory via the transceiver by continuously sending location data to the transceiver and stored in the vehicle memory, wherein the location data corresponds to the current location of the vehicle;
wherein the electronic vehicle processor is configured to read the computer memory in order to continuously calculate a path depending on the location data of the current location of the vehicle and sensor data received by the vehicle memory;
wherein the path includes a plurality of stops calculated by the vehicle processor by using vehicle sensor data and predetermined delivery location data stored in the vehicle memory;
wherein the vehicle includes a powertrain system controlled by the vehicle processor; and
wherein the vehicle processor is configured to send commands to the powertrain system in order to autonomously drive the vehicle along the path.

12. The vehicle of claim 11, wherein the positioning system is a global navigation satellite system (GNSS).

13. The delivery system of claim 11, wherein the vehicle sensor is at least one of a radar and lidar system.

14. The delivery system of claim 13, wherein the vehicle sensor receives electromagnetic waves from external objects and stores the data representing the electromagnetic waves in the vehicle memory.

15. The delivery system of claim 14, wherein the data representing the electromagnetic waves in the vehicle memory is utilized by the processor to follow a delivery person.

16. The delivery system of claim 15, wherein each stop of the plurality of stops are calculated as the minimum distance for the delivery person to complete a delivery associated with each predetermined delivery location data.

17. The delivery system of claim 11, further comprising one or more autonomous drones configured to aid delivery of objects to predetermined delivery locations.

18. The delivery system of claim 11, wherein the vehicle is configured to receive an input signal from one predetermined delivery location of the predetermined delivery locations, wherein the input signal includes information regarding a package stored in the vehicle associated with the one predetermined delivery location.

19. The delivery system of claim 18, wherein the vehicle processor is configured to recalculate the path using the information in the input signal.

20. The delivery system of claim 11, wherein the powertrain system is an electric propulsion powertrain system.
